(19) United States
(12) Patent Application Publication
(10) Pub. No.: US 2006/0115671 A1
(43) Pub. Date: Jun. 1, 2006

(54) Copper-clad laminate

(75) Inventors: Ryuzo Shinta, Chiba (JP); Yasufumi Matsumura, Chiba (JP); Hironobu Kawasato, Chiba (JP)

Correspondence Address: BIRCH STEWART KOLASCH & BIRCH, PO BOX 747, FALLS CHURCH, VA, 22040-0747, US

(73) Assignee: NIPPON STEEL CHEMICAL CO., LTD.

(21) Appl. No.: 11/288,303

(22) Filed: Nov. 29, 2005

(30) Foreign Application Priority Data
Nov. 30, 2004 (JP) 345609/2004

(51) Int. Cl. B21D 39/00; B32B 15/08

(52) U.S. Cl. 428/624; 428/626

(57) ABSTRACT

This invention relate to a copper-clad laminate with good adhesion between a copper foil and a layer of polyimide resin useful for high-density printed wiring boards. The copper-clad laminate having a copper foil treated with a heterocyclic compound containing nitrogen and sulfur as an organic surface treating agent and a layer of polyimide resin satisfying either of the following requirements: the concentration of sulfur atoms derived from the organic surface treating agent in the interface of copper and polyimide is in the range of 0.01-0.24 wt % as determined by an Energy dispersive X-ray spectroscopy (EDX); the weight of sulfur atoms derived from the organic surface treating agent per unit area of the copper foil is in the range of 2.5-3.1 mg/m²; and the concentration of sulfur atoms derived from the organic surface treating agent existing in the range from the surface to a depth of 16 nm of the copper foil is in the range of 1.73-2.30 atom % as determined by X-ray photoelectron spectroscopy (XPS).

### FIELD OF TECHNOLOGY

This invention relates to a copper-clad laminate which can be used advantageously in parts for circuits of electronic instruments.

### BACKGROUND TECHNOLOGY

Printed wiring boards fabricated from laminates of insulating materials and conductive materials are used for the circuits of electronic instruments. Printed wiring boards are prepared by forming conductive patterns based on electrical design on the surface (or in the inside) of insulating materials and, depending upon the kind of resins used for insulating materials, they are roughly divided into rigid printed wiring boards and flexible printed wiring boards. Flexible printed wiring boards are characterized by their flexibility and they are essential for connecting parts which are flexed repeatedly at all times such as connecting parts of cell phones. As flexible wiring boards can be stowed in a flexed condition inside electronic instruments, they are also used as space-saving wiring materials. Base resins for the flexible substrates to be used in flexible printed wiring boards are mostly polyimideesters and polyimides and the latter resins predominate in usage. Copper is generally used as a conductive material on account of its good conductivity.

There are structurally three-layer flexible substrates and two-layer flexible substrates. A three-layer flexible substrate is a laminate constructed of a base film, an adhesive and a copper foil and an adhesive based on a resin such as epoxy and acrylic is used here to bond the base film and the copper foil to form an integrated body. On the other hand, a two-layer flexible substrate is a laminate constructed of a base film and a copper foil by a special technique without using an adhesive. As two-layer flexible substrates use only highly heat-resistant polyimide resins as organic insulating materials, they are more reliable than three-layer substrates which use adhesives such as epoxy resins and acrylic resins inferior in heat resistance to polyimide resins. Furthermore, two-layer substrates enable reduction of the thickness of circuits as a whole and their usage is on the increase.

In recent years, a demand for improved performance and functionality of electronic instruments is increasing and this is followed by a demand for higher density of printed wiring boards which are used in the circuits of electronic instruments. To attain higher density of printed wiring boards, it is necessary to reduce the width and spacing of circuit wiring, that is, to realize fine-pitched wiring. As described earlier, a substrate for a printed wiring board is a laminate of a conductive material and a resin film and, up to the present, a copper foil which is either highly rough as prepared or treated for roughening has been used as a conductive material to increase adhesion to resins. However, the use of a laminate prepared from a highly rough copper foil in applications involving fine-pitched wiring causes problems such as the following; a part of the copper foil remains on the resin and the width of a circuit tends to become irregular due to reduced linearity in etching during formation of a circuit by etching. Therefore, it is desirable to use a copper foil with reduced surface roughness for high-density and fine-pitched wiring of printed wiring boards. However, a copper foil with reduced surface roughness produces a smaller anchor effect, that is, the resin holds on the irregular surface of the copper foil less securely. As a result, adequate adhesive strength cannot be obtained mechanically and the problem arising therefrom is low adhesive strength between the insulating layer and the copper foil.

Under the circumstances, a copper-clad laminate prepared by using a copper foil treated with an organic compound to improve adhesion has been proposed. For example, JP61-266241A discloses a copper-clad laminate which is prepared from a copper foil which is treated by immersing in a liquid containing a heterocyclic compound such as benzotriazole and aminoimidazole and dried. However, this method faced the problem of a poor effect for improving adhesion probably because of an inadequate amount of the heterocyclic compound applied to the surface of the copper foil.

JP2003-27162A discloses a copper alloy foil intended for use in a laminate wherein the thickness of an anticorrosive film on the foil is kept at 5 nm or less in order to improve the wettability of the foil by polyamic acids. An organic anticorrosive agent such as benzotriazole is used here in forming the anticorrosive film on the copper foil. However, the use of an organic anticorrosive agent is aimed at improving the wettability of the copper alloy foil by polyamic acids. Therefore, a laminate of stabilized adhesion can be prepared, but marked improvement in adhesion by an organic anticorrosive agent cannot be expected.

### SUMMARY OF THE INVENTION

As described above, copper-clad laminates prepared from copper foils treated with organic surface treating agents and polyimide resins have been reported, but none has satisfactorily improved the adhesive strength. An object of this invention is to provide a copper-clad laminate with improved adhesion and reliability prepared by using an adequate amount of an organic surface treating agent containing sulfur which has an effect to improve the adhesive strength between a copper foil and a resin.

To attain the aforementioned object, the inventors of this invention have conducted intensive studies, found that a copper-clad laminate free from the aforementioned problems can be obtained by using an organic surface treating agent containing sulfur atoms while specifying the range of its amount, that is, by specifying the amount of sulfur atoms derived from an organic surface treating agent existing between copper and polyimide and completed this invention.

This invention relates to a copper-clad laminate of a copper foil treated with an organic surface treating agent and a layer of polyimide resin wherein the concentration of sulfur atoms derived from the organic surface treating agent existing in the interface between the copper foil and the layer of polyimide resin is in the range of 0.01-0.24 wt % as determined by an Energy dispersive X-ray spectroscopy (EDX).

When viewed from another angle, this invention relates to a copper-clad laminate of a copper foil treated with an organic surface treating agent and a layer of polyimide resin wherein the weight of the sulfur atoms derived from the organic surface treating agent per unit area of the copper foil treated with the organic surface treating agent is in the range of 2.5-3.1 mg/m² or the concentration of the sulfur atoms derived from the organic surface treating agent in the range from the surface to a depth of 16 nm of the copper foil treated with the organic surface treating agent is in the range of 1.73-2.30 atom % as determined by an X-ray photoelectron spectroscopy (XPS).

According to this invention, a copper-clad laminate is prepared by treating a copper foil by an organic surface treating agent in such a manner as to satisfy at least one of the following requirements, coating the resulting copper foil with a solution of the precursor of polyimide resin and heating; 1) the weight of the sulfur atoms derived from the organic surface treating agent per unit area of the copper foil treated with the organic surface treating agent is in the range of 2.5-3.1 mg/M² and 2) the concentration of the sulfur atoms derived from the organic surface treating agent in the range from the surface to a depth of 16 nm of the copper foil treated with the organic surface treating agent is in the range of 1.73-2.30 atom % as determined by an XPS.

The copper-clad laminate of this invention is described below.

Although a copper foil to be used in this invention is not limited, the thickness is preferably in the range of 5-50 μm, more preferably in the range of 8-30 μm, for use in flexible substrates. A thinner copper foil is suitable for laminates intended for applications requiring fine-pitched wiring and the thickness in this case is preferably in the range of 8-20 μm, The roughness of a copper foil is not limited, but the ten-point height of irregularities (Rz) is 1.5 μm or less, preferably 0.1-3 μm, more preferably 0.1-1.5 μm, most preferably 0.1-1.0 μm, for applications requiring fine-pitched wiring. A copper foil as used in this invention includes a copper alloy foil containing copper as the principal ingredient.

The sulfur atoms existing in the interface of a laminate prepared according to this invention are derived from an organic surface treating agent used for treating the surface of a copper foil. This organic surface treating agent is usually applied to a copper foil and thereafter a layer of polyimide is provided on the treated copper foil. The organic surface treating agent here is an organic compound containing sulfur atoms and preferably a heterocyclic compound containing nitrogen and sulfur atoms. A heterocyclic compound containing a thiol group as a functional group is used preferably and, from the standpoint of better adhesion to polyimide resins, a heterocyclic compound containing amino and thiol groups is used more preferably.

The organic surface treating agents of this kind include 2-amino-1,3,5-triazine-4,6-dithiol, 3-amino-1,2,4-triazole-5-thiol, 2-amino-5-trifluoromethyl-1,3,4-thiadiazole, 5-amino-2-mercaptobenzimidazole, 6-amino-2-mercaptobenzothiazole, 4-amino-6-mercaptopyrazolo[3,4-d]pyrimidine, 2-amino-4-methoxybenzothiazole, 2-amino-4-phenyl-5-tetradecylthiazole, 2-amino-5-phenyl-1,3,4-thiadiazole, 2-amino-4-phenylthiazole, 4-amino-5-phenyl-4H-1,2,4-triazole-3-thiol, 2-amino-6-(methylsulfonyl)benzothiazole, 2-amino-4-methylthiazole, 2-amino-5-(methylthio)-1,3,4-thiadiazole, 3-amino-5-methylthio-1 H-1,2,4-thiazole, 6-amino-1-methyluracil, 3-amino-5-nitrobenzisothiazole, 2-amino-1,3,4-thiadiazole, 5-amino-1,3,4-thiadiazole-2-thiol, 2-aminothiazole, 2-amino-4-thiazoleacetic acid, 2-amino-2-thiazoline, 2-amino-6-thiocyanatobenzothiazole, DL-α-amino-2-thiopheneacetic acid, 4-amino-6-hydroxy-2-mercaptopyrimidine, 2-amino-6-purinethiol, 4-amino-5-(4-pyridyl)-4H-1,2,4-triazole-3-thiol, N⁴-(2-amino-4-pyrimidinyl)sulfanilamide, 3-aminorhodanine, 5-amino-3-methylisothiazole, 2-amino-α-(methoxyimino)-4-thiazoleacetic acid and thioguanine, but are not limited to these compounds. They can be used singly or as a combination of two or more.

The copper-clad laminate of this invention can be obtained by laminating a layer of polyimide resin to the surface of a copper foil treated with one or more of the aforementioned organic surface treating agents. The adhesive strength between the copper foil and the layer of polyimide resin is related to the amount of the organic surface treating agent adhering to the copper foil. As the organic surface treating agent contains sulfur atoms, the amount of the organic surface treating agent is adequately decided by the sulfur atoms derived from the organic surface treating agent.

The amount of sulfur derived from the organic surface treating agent adhering to the copper foil is decided by either of the following quantities: 1) the weight of sulfur atoms derived from the organic surface treating agent per unit area of the copper foil treated with the organic surface treating agent (hereinafter referred to as the weight of sulfur per unit area); 2) the concentration of sulfur atoms derived from the organic surface treating agent existing in the range from the surface to a depth of 16 nm of the copper foil treated with the organic surface treating agent as determined by an XPS (hereinafter referred to as the concentration of sulfur at 0-16 nm); and 3) the average concentration of sulfur atoms derived from the organic surface treating agent existing on the surfaces of the copper foil and the layer of polyimide resin when a copper-clad laminate is separated along the interface (hereinafter referred to as the concentration of sulfur on the separated surface). A general tendency here is that, when one or more of these requirements are satisfied, the other requirements are also satisfied. The amount of sulfur per unit area is expressed as mg per 1 m² of the copper foil, the concentration of sulfur at 0-16 nm as % of sulfur atoms existing in the range from the surface to a depth of 16 nm (number of sulfur atoms)/(total number of atoms)×100 and the concentration of sulfur on the separated surface as wt % of sulfur atoms existing on the separated surface.

The weight of sulfur per unit area is controlled in the range of 2.5-3.1 mg/m², preferably in the range of 2.5-3.0 mg/m². The concentration of sulfur at 0-16 nm is controlled in the range of 1.73-2.30 atom %, preferably in the range of 1.75-2.20 atom %. The concentration of sulfur on the separated surface is controlled preferably in the range of 0.01-0.24 wt %, more preferably in the range of 0.02-0.20 wt %, most preferably in the range of 0.03-0.10 wt %. These quantities are determined by the methods described later in the examples. The amount of the organic surface treating agent existing in the copper foil treated with the organic surface treating agent can be adjusted by changing the condition for treatment such as the kind of organic surface treating agent and the treating time or the condition for cleaning after the treatment.

In the copper-clad laminate prepared according to this invention, the sulfur atoms derived from the surface treating agent exist in the interface between the copper foil and the layer of polyimide resin. The concentration of the sulfur atoms in the interface is determined as the concentration of sulfur on the separated surface in wt %. The concentration of sulfur on the separated surface is related to the amount of the organic surface treating agent existing in the copper foil treated with the organic surface treating agent. This concentration is preferably in the range of 0.01-0.24%. The adhesive strength tends to decrease when the concentration of sulfur on the separated surface is below the aforementioned range. When the concentration of sulfur on the separated surface is high, delamination occurs in the interface wherever the organic surface treating agent exists in excess. On the other hand, when an organic surface treating agent is not applied to the surface of a copper foil, the adhesive strength is markedly low in the initial stage. For this reason, it becomes necessary to provide an optimal amount of an organic surface treating agent, that is, an optimal concentration of sulfur atoms in the adhesive interface of a copper-clad laminate. The concentration of sulfur on the separated surface derived from the organic surface treating agent existing in this interface is determined by testing the separated surfaces of the copper foil and the layer of polyimide resin by an EDX analyzer. Concretely, a copper-clad laminate is separated into a copper foil and a layer of polyimide resin and the separated surface of the copper foil (or the surface which has been in contact with the layer of polyimide resin) and the separated surface of the layer of polyimide resin (or the surface which has been in contact with the copper foil) are respectively determined for the concentration of sulfur by an EDX analyzer.

The concentration of sulfur here is calculated by determining the concentrations of sulfur on the separated surfaces of the copper foil and the layer of polyimide resin and averaging the two. In the cases where some of the sulfur atoms are derived from the polyimide resin itself, the concentration of sulfur derived from the organic surface treating agent is calculated by preparing a copper-clad laminate from the polyimide resin without using the organic surface treating agent, determining the concentration of sulfur atoms on the separated surface as a blank and subtracting the blank value from the found value. For example, where the concentrations of sulfur on the separated surfaces of the copper foil and the layer of polyimide resin are respectively S1 and S2 and the corresponding blank values are S3 and S4, the concentration of sulfur derived from the organic surface treating agent is calculated as [(S1-S3)+(S2-S4)]/2.

The copper-clad laminate of this invention produces roughly the same effect when the amount of sulfur derived from the organic surface treating agent in the copper foil is controlled in a specified range or the amount of sulfur derived from the organic surface treating agent in the separated surfaces of the copper foil and the layer of polyimide is controlled in a specified range. This is to say that the amount of sulfur in the copper foil is closely related to the amount of sulfur on the separated surfaces of the copper foil and the layer of polyimide. Therefore, it would suffice to exercise the control in either way, but it would be more desirable to satisfy two or three of the quantities specified for 1) the weight of sulfur per unit area, 2) the concentration of sulfur at 0-16 nm and 3) the concentration of sulfur on the separated surface. That is, improved adhesive strength would be secured advantageously by satisfying two or three of the aforementioned requirements.

The adhesive strength of polyimide to copper in the copper-clad laminate of this invention is desirably 0.7 kN/m or more as 180° peel strength. The reliability of the laminate as a wiring material in electronic instruments may be affected adversely when the adhesive strength is below this value.

A copper-clad laminate is prepared as follows according to this invention.

The copper foil is preferably cleaned in advance by an aqueous acid solution to remove oxides on the surface. This treatment is called soft etching. The aqueous acid solution to be used here may be any aqueous solution as long as it is acidic and particularly desirable are aqueous hydrochloric acid solution or an aqueous sulfuric acid solution. The concentration is in the range of 0.5-50 wt %, preferably in the range of 1-5 wt %. The pH is preferably kept at 2 or below.

The cleaned copper foil is then treated by a solution of an organic surface treating agent. The solvents useful for dissolving organic surface treating agents include hydrocarbon-based alcohols containing 1-8 carbon atoms such as methanol, ethanol, propanol, isopropanol, butanol, tert-butanol, pentanol, hexanol, heptanol and octanol, hydrocarbon-based ketones containing 3-6 carbon atoms such as acetone, propanone, methyl ethyl ketone, pentanone, hexanone, methyl isobutyl ketone and cyclohexanone, hydrocarbon-based ethers containing 4-12 carbon atoms such as diethyl ether, ethylene glycol dimethyl ether, diethylene glycol dimethyl ether, diethylene glycol diethyl ether, diethylene glycol dibutyl ether and tetrahydrofuran, hydrocarbon-based esters containing 3-7 carbon atoms such as methyl acetate, ethyl acetate, propyl acetate, butyl acetate, γ-butyrolactone and diethyl malonate, amides containing 3-6 carbon atoms such as dimethylformamide, dimethylacetamide, tetramethylurea and hexamethylphosphoric triamide, sulfoxides containing 2 carbon atoms such as dimethyl sulfoxide, halogenated compounds containing 1-6 carbon atoms such as chloromethane, bromomethane, dichloromethane, chloroform, carbon tetrachloride, dichloroethane, 1,2-dichloroethane, 1,4-dichlorobutane, trichloroethane, chlorobenzene and o-dichlorobenzene and hydrocarbons containing 4-8 carbon atoms such as butane, hexane, heptane, octane, benzene, toluene and xylene. The solvents useful for this invention are not limited to the aforementioned compounds.

As described earlier, a heterocyclic compound containing a thiol group can be used as an organic surface treating agent. The concentration of the organic surface treating agent is preferably in the range of 0.0001-1 mol/l. The use of a low concentration may be considered advantageous in that less organic surface treating agent adheres to the surface of a copper foil. However, an excessively low concentration would not produce the effect for improving the adhesive strength between copper and resin and a preferred range is 0.0005-0.002 mol/l.

In treating the surface of a copper foil with the aforementioned treating solution, what is required is the contact of the whole surface of the copper foil with the treating solution and uniform contact is desirable although the method to be employed therefor is not limited. The copper foil may be immersed in or sprayed with the treating solution or coated with the treating solution with the use of a suitable tool. The temperature of the treating solution is controlled preferably in the range of 10-100° C., more preferably in the range of 10-50° C.

When the surface treatment is over, the copper foil is submitted to a cleaning step where the excess organic surface treating agent adhering to the surface is removed by dissolving in an organic solvent. An organic solvent which can dissolves the organic surface treating agent may be used in this step, for example, any of the aforementioned organic solvents can be used. Economically, methanol is used advantageously because of its low cost.

The method for cleaning the surface of the copper foil by an organic solvent is not limited. The copper foil is cleaned by immersing in a solvent, spraying with a solvent or wiping with a suitable material soaked in a suitable solvent. Care should be exercised in this cleaning step to remove only the excess, but not the whole, of the organic surface treating agent from the surface of the copper foil. It is advantageous to remove the organic surface treating agent in such a manner as to leave a monomolecular film of the organic surface treating agent on the surface of the copper foil. This can be done by a procedure consisting of a sequence of washing with water, the aforementioned cleaning with an organic solvent and washing with water. The temperature of the solvent in the cleaning step is preferably in the range of 0-100° C., more preferably in the range of 5-50° C. The cleaning time is preferably in the range of 1-1000 seconds, more preferably in the range of 3-600 seconds. The amount of solvent is preferably in the range of 1-500 L, more preferably in the range of 3-50 L, per 1 m² of the copper foil.

A copper foil to which the organic surface treating agent adheres is prepared in the aforementioned manner. The copper foil contains a prescribed amount of sulfur atoms derived from the organic surface treating agent. This copper foil is coated with a solution of a resin and then heated to form a laminate having a layer of the resin and the copper foil. The resin is polyimide and a solution of its precursor is preferably used here.

A solution of the precursor of polyimide is synthesized by polycondensing a tetracarboxylic acid or its acid anhydride as an acid component and a diamine as an amine component in an organic polar solvent under the anhydrous condition at 0-100° C. It is allowable to use a polyimide precursor containing an acryloyl group or a photosensitive polyimide precursor containing an o-nitrobenzyl ester group. A photosensitive polyimide precursor may contain a photopolymerization initiator, a photosensitizer, a crosslinking auxiliary and the like if necessary.

The diamines used as raw materials for polyimide precursors include p-phenylenediamine, m-phenylenediamine, 2,4-diaminotoluene, 1,3-bis(3-aminophenoxy)benzene, 4,4′-diamino-2′-methoxybenzanilide, 3,4′-diaminodiphenyl ether, 4,4′-diamino-2,2′-dimethylbiphenyl, 4,4′-diaminodiphenyl ether, 2,2′-bis[4-(4-aminophenoxy)phenyl]propane, 4,4′-bis(3-aminophenoxy)biphenyl, 4,4′-diaminodiphenylpropane, 3,3′-diaminobenzophenone and 4,4′-diaminodiphenyl sulfide. These diamines can be used singly or as a combination of two kinds or more.

The tetracarboxylic acids or their acid anhydrides as raw materials for polyimide precursors include pyromellitic dianhydride, 3,4,3′,4′-benzophenonetetracarboxylic acid dianhydride, 3,4,3′,4′-diphenylsulfonetetracarboxylic acid dianhydride, 3,3′,4,4′-biphenyltetracarboxylic acid dianhydride and 4,4′-oxydiphthalic acid dianhydride. They can be used singly or as a combination of two kinds or more.

The solvents to be used for polyimide precursor solutions include N-methylpyrrolidone (NMP), dimethylformamide (DMF), dimethylacetamide (DMAc), dimethyl sulfoxide (DMSO), dimethyl sulfate, sulfolane, butyrolactone, cresol, phenol, halogenated phenols, cyclohexane, dioxane, tetrahydrofuran, diglyme and triglyme. These solvents can be used singly or as a combination of two kinds or more. Preferred are DMAc and NMP. The solvent is used in an amount enough to dissolve the components homogeneously.

In the preparation of a copper-clad laminate, a copper foil is coated with a polyimide precursor, the solvent is dried off and the remaining layer of the polyimide precursor is imidized by heating. The solvent is removed preferably at 60-200° C. for 1-300 minutes, more preferably at 100-180° C. for 2-20 minutes, and the curing is effected preferably at 130-420° C. for 1-300 minutes, more preferably at 180-380° C. for 3-30 minutes. The method for drying off the solvent and the subsequent curing is not limited and it may be a batch process wherein the temperature is raised stepwise or a continuous process wherein the temperature is raised continuously.

A copper-clad laminate is a single-sided laminate composed of a layer of polyimide and a copper foil or a double-sided laminate composed of a layer of polyimide and copper foils on both sides and the thickness of the polyimide layer is preferably in the range of 3-100 μm, more preferably in the range of 10-50 μm.

### PREFERRED EMBODIMENTS OF THE INVENTION

This invention is described below with reference to the accompanying examples. The measurement and evaluation in the examples are performed as described below unless otherwise noted.

Determination of the Concentration of Sulfur on the Separated Surface:

The analysis of sulfur was made using an Energy dispersive X-ray spectroscopy (EDX) (available from HORIBA, Ltd.) under the following conditions: accelerating voltage, 10 kv; emission current, 10.0 μA; collecting time, 600 sec. The surface concentration obtained was taken as the concentration of sulfur on the separated surface. This quantity is the ratio in mass, expressed in percentage, of the sulfur atoms on the separated surface to the total sulfur atoms detected and is the average of the concentrations of sulfur on the copper foil and the layer of polyimide resin.

Determination of the Weight of Sulfur Per Unit Area:

A copper foil treated with an organic surface treating agent was analyzed in conformity with the combustion-infrared absorption method (JIS G-1211) using a carbon-sulfur analyzer (C/S-444 available from LECO Co., Ltd.). The ratio of the weight of sulfur in the specimen to the weight of the specimen was obtained in percentage and the weight of sulfur per unit area of the copper foil was calculated. In the cases where the copper foil before the surface treatment contains sulfur, the amount of this sulfur was subtracted from the aforementioned analytical value to determine the weight of sulfur derived from the organic surface treating agent.

Determination of the Concentration of Sulfur At 0-16 nm:

A copper foil treated with an organic surface treating agent was analyzed using an X-ray photoelectron spectroscopy (XPS) (Quantum 2000 type, available from PHI Co., Ltd.) under the following conditions: X-ray source, AlKα (1486.6 eV); X-ray output, 15 kV, 25 W; degree of vacuum in the analytical laboratory, 2.7×10⁻⁷ Torr; range of measurement, 100 μm in diameter from the surface to a depth of 16 nm. In the cases where the copper foil before the surface treatment contains sulfur, the amount of this sulfur was subtracted from the aforementioned analytical value to determine the weight of sulfur derived from the organic surface treating agent.

Evaluation of Adhesive Strength:

The adhesive strength between metal and polyimide was determined by forming a layer of polyimide resin on a copper foil, cutting the laminate by a press into a 10 mm-wide strip and separating the copper foil in the 180° direction by using STROGRAPH V1 (available from Toyo Seiki Co., Ltd.).

### SYNTHETIC EXAMPLE 1

A varnish containing polyamic acids was prepared as follows. In a three-necked flask were placed 425 g of dimethylacetamide, 31.8 g of 2,2′-dimethyl-4,4′-diaminobiphenyl and 4.9 g of 1,3-bis(4-aminophenoxy)benzene and the mixture was stirred at room temperature for 30 minutes. Thereafter, 28.6 g of pyromellitic dianhydride and 9.6 g of biphenyl-3,4,3′,4′-tetracarboxylic acid dianhydride were added and the mixture was stirred at room temperature for 3 hours in an atmosphere of nitrogen. The viscosity was 28000 cps at 30° C.

### EXAMPLE 1

An electrodeposited copper foil not submitted to surface treatment (Rz approximately 0.8 μm, thickness 18 μm, size 20 cm×13 cm) was used. The copper foil was immersed in a 5% aqueous solution of hydrochloric acid (pH <1, temperature approximately 20° C.) for 60 seconds to remove an oxide film on the surface of the copper foil. The copper foil was then washed sufficiently with deionized water to remove the residual acid and compressed air was blown against the foil to dry it. The copper foil thus treated was immersed in a bath containing a solution of 160 mg of 2-amino-1,3,5-triazine-4,6-dithiol as an organic surface treating agent in 1 L of methanol at approximately 20° C. for 30 seconds to effect surface treatment.

The copper foil was then immersed in 750 mL of deionized water at approximately 20° C. for 60 seconds and then compressed air was blown against the foil for approximately 15 seconds to dry it (first cleaning). Thereafter, the copper foil was immersed in 750 mL of methanol at approximately 20° C. for 60 seconds and then in 750 mL of deionized water at approximately 20° C. for 60 seconds to remove an excess of the organic surface treating agent adhering to the copper foil and compressed air was blown against the foil to dry it (second cleaning).

The weight of sulfur atoms derived from the 2-amino-1,3,5-triazine-4,6-dithiol adhering to the surface of the copper foil after the aforementioned surface treatment or the weight of sulfur per unit area was 2.76 mg/m². The concentration of sulfur atoms existing in the range from the surface to a depth of 16 nm of the copper foil or the concentration of sulfur at 0-16 nm was 1.93 atom % when determined by an XPS.

The copper foil treated in this manner was coated with a varnish containing polyamic acids to a thickness of approximately 50 μm, dried at 130° C. for 2 minutes and cured by heating at a final temperature of 360° C. for 3 minutes thereby effecting imidation. The product was a copper-clad laminate with a two-layer structure consisting of the layer of polyimide and the copper foil. The thickness of the polyimide layer was approximately 25 μm. The copper-clad laminate thus obtained was cut into a 10 mm-wide strip and tested for the 180° peel strength at room temperature by using a tensile tester. The adhesive strength was 1.25 kN/m. The concentrations of sulfur on the separated surfaces of the copper foil and the layer of polyimide resin are respectively 0.14 wt % and 0.01 wt % when determined by an EDX and the average of the two or the concentration of sulfur on the separated surface was 0.075 wt %.,

### EXAMPLE 2

The experiment was carried out as in Example 1 with the exception of using 80 mg of 2-amino-1,3,5-triazine-4,6-dithiol as an organic surface treating agent in the surface treatment of the copper foil.

### EXAMPLE 3

The experiment was carried out as in Example 1 with the exception of performing the surface treatment by immersing the copper foil in a solution of 160 mg of 2-amino-1,3,5-triazine-4,6-dithiol in 1 L of methanol at approximately 20° C. for 30 seconds and thereafter performing only the first cleaning and not the second cleaning involving cleaning with methanol.

### EXAMPLE 4

The experiment was carried out as in Example 1 with the exception of performing the surface treatment by immersing the copper foil in a solution of 160 mg of 2-amino-1,3,5-triazine-4,6-dithiol in 1 L of methanol at approximately 20° C. for 30 seconds and not performing the first cleaning nor the second cleaning.

### EXAMPLE 5

The experiment was carried out as in Example 1 with the exception of using 174 mg of 4,5-diamino-2,6-dimercaptopyrimidine in place of 2-amino-1,3,5-triazine-4,6-dithiol.

### EXAMPLE 6

The experiment was carried out as in Example 1 with the exception of using 150 mg of 5-amino-1,3,4-thidiazole-2-thiol in place of 2-amino-1,3,5-triazine-4,6-dithiol.

### COMPARATIVE EXAMPLE 1

The experiment was carried out as in Example 1 with the exception of not performing the surface treatment of the copper foil by the solution of 2-amino-1,3,5-triazine-4,6-dithiol.

### COMPARATIVE EXAMPLE 2

The experiment was carried out as in Example 4 with the exception of using 320 mg of 2-amino-1,3,5-triazine-4,6-dithiol.

### COMPARATIVE EXAMPLE 3

The experiment was carried out as in Example 1 with the exception of using 177 mg of 1,3,5-triazine-2,4,6-trithiol in place of 2-amino-1,3,5-triazine-4,6-dithiol.

### COMPARATIVE EXAMPLE 4

The experiment was carried out as in Example 1 with the exception of using 182 mg of 6-amino-2-mercaptobenzothiazole in place of 2-amino-1,3,5-triazine-4,6-dithiol.

The results are summarized in Tables 1 and 2.

TABLE 1

| | Weight of sulfur | Concentration of sulfur |
|---|---|---|
| | per unit area | at 0-16 nm |
| | (mg/m²) | (atom. %) |
| Example 1 | 2.76 | 1.93 |
| Example 2 | 2.64 | 1.85 |
| Example 3 | 2.59 | 1.95 |
| Example 4 | 2.90 | 2.10 |
| Example 5 | 2.54 | 1.78 |
| Example 6 | 2.94 | 2.06 |
| Comp. ex. 1 | 0.00 | 0.00 |
| Comp. ex. 2 | 3.27 | 2.35 |
| Comp. ex. 3 | 3.74 | 2.62 |
| Comp. ex. 4 | 2.42 | 1.70 |

TABLE 2

| | Concentration of sulfur on separated | | | |
|---|---|---|---|---|
| | surface (%) | | | Adhesive |
| | Copper foil | | | strength |
| | side | Resin side | Average | (kN/m) |
| Example 1 | 0.14 | 0.01 | 0.075 | 1.25 |
| Example 2 | 0.11 | 0.01 | 0.060 | 1.00 |
| Example 3 | 0.15 | 0.04 | 0.085 | 0.89 |
| Example 4 | 0.16 | 0.05 | 0.105 | 0.80 |
| Example 5 | 0.15 | 0.04 | 0.085 | 0.91 |
| Example 6 | 0.17 | 0.06 | 0.115 | 1.06 |
| Comp. ex. 1 | 0.00 | 0.00 | 0.00 | 0.10 |
| Comp. ex. 2 | 0.37 | 0.13 | 0.25 | 0.50 |
| Comp. ex. 3 | 0.52 | 0.17 | 0.345 | 0.15 |
| Comp. ex. 4 | 0.38 | 0.13 | 0.255 | 0.34 |

What is claimed is:

1. A copper-clad laminate comprising a layer of polyimide resin on a copper foil treated with an organic surface treating agent wherein the concentration of sulfur atoms derived from said organic surface treating agent in the interface between the copper foil and the layer of polyimide resin is in the range of 0.01-0.24 wt % as determined by an Energy dispersive X-ray spectroscopy (EDX).

2. A copper-clad laminate as described in claim 1 wherein the weight of the sulfur atoms derived from the organic surface treating agent per unit area of the copper foil treated with the organic surface treating agent is in the range of 2.5-3.1 mg/m².

3. A copper-clad laminate as described in claim 1 wherein the concentration of the sulfur atoms derived from the organic surface treating agent in the range from the surface to a depth of 16 nm of the copper foil treated with the organic surface treating agent is in the range of 1.73-2.30 atom % as determined by an X-ray photoelectron spectroscopy (XPS).

4. A copper-clad laminate as described in claim 1 wherein the organic surface treating agent is a heterocyclic compound containing at least nitrogen and sulfur atoms.

5. A copper-clad laminate as described in claim 1 wherein the adhesive strength between the layer of polyimide resin and the copper foil is 0.7 kN/m or more expressed as 180° peel strength.

6. A copper-clad laminate having a layer of polyimide resin on a copper foil treated with an organic surface treating agent which satisfies at least one of the following requirements:
1) the weight of the sulfur atoms derived from the organic surface treating agent per unit area of the copper foil treated with the organic surface treating agent is in the range of 2.5-3.1 mg/m²;
2) the concentration of the sulfur atoms derived from the organic surface treating agent in the range from the surface to a depth of 16 nm of the copper foil treated with the organic surface treating agent is in the range of 1.73-2.30 atom % as determined by an X-ray photoelectron spectroscopy (XPS); and
3) the concentration of sulfur atoms derived from said organic surface treating agent in the interface between the copper foil and the layer of polyimide resin is in the range of 0.01-0.24 wt % as determined by an Energy dispersive X-ray spectroscopy (EDX).

7. A copper-clad laminate as described in claim 6 wherein the organic surface treating agent is a heterocyclic compound containing at least nitrogen and sulfur atoms.

8. A copper-clad laminate as described in claim 6 wherein the adhesive strength between the layer of polyimide resin and the copper foil is 0.7 kN/m or more expressed as 180-degree peel strength.

9. A copper-clad laminate as described in claim 6 wherein the surface roughness of the copper foil on the layer of polyimide resin is 1.5 μm or less as ten-point height of irregularities (Rz).
